(19) United States
(12) Patent Application Publication
(10) Pub. No.: US 2010/0062112 A1
(43) Pub. Date: Mar. 11, 2010

(54) BEVERAGE WITH ENERGIZING EFFECTS

(76) Inventor: Vladimír Daniska, Nitra (SK)

Correspondence Address: JORDAN AND HAMBURG LLP, 122 EAST 42ND STREET, SUITE 4000, NEW YORK, NY, 10168, US

(21) Appl. No.: 12/312,061

(22) PCT Filed: Oct. 23, 2007
(86) PCT No.: PCT/SK2007/000009

§ 371 Date: Apr. 23, 2009

(30) Foreign Application Priority Data
Oct. 24, 2006 (SK) PP 5092-2006

(51) Int. Cl. A23L 2/52; A23L 2/02; A23L 1/302; A23L 2/00

(52) U.S. Cl. 426/66; 426/590; 426/599; 426/72

(57) ABSTRACT

The beverage with energizing effects without taurine contains extract of guarana and tribulus terrestris, favourably 50 to 1500 mg of guarana extract per 1000 ml of drinkable liquid and 50 to 400 mg of extract of tribulus terrestris per 1000 ml of drinkable liquid. Drinkable liquid is water, favourably mineral water. Used guarana extract contains 15% to 30% by weight, favourably 22% by weight of natural caffeine and used extract of tribulus terrestris contains 25% to 60% by weight, favourably 45% by weight of steroid saponin. The beverage can contain, additionally to its content and over the extent of guarana content, added caffeine, favourably natural caffeine in amount of 50 to 200 mg per 1000 of drinkable liquid. To improve the positive effects of the beverage it can contain the vitamin mixture of the class C and/or B. In typical example the beverage is pasteurised with no saturation by CO₂. According to undergone tests and special observations, the beverage has positive influence on LDL cholesterol lowering, on overall stimulation of metabolic reactions and improvement of more physiological parameters.

### FIELD OF THE TECHNOLOGY

The invention relates a beverage with energizing effects with no content of taurine, positive influence on LDL cholesterol reduction, overall stimulation of metabolic reactions and normalization of more physiological parameters.

### PRESENT CONDITION OF THE TECHNOLOGY

Known are many stimulating and energizing beverages which contain caffeine, taurine and other active substances. The disadvantage of such beverages is that their content has besides positive stimulating effects also a range of negative side effects. Permanent and regular usage of such beverages can lead to malfunction of metabolism.

Frequently used active substance of energizing drinks is taurine which bothers cardio-vascular system and has negative influence on metabolism. Regular and continuous consumption of beverages containing taurine is not recommended not even to healthy people.

There is a wide range of beverages with stimulating effects which contain combinations of different synthetically prepared active substances though by the need to gain noticeable positive effects the needed concentration of active substances causes undesirable tendency and such beverages are often badly tolerated, at the end with bad subjective feeling.

Up to date known stimulating, energizing beverages are carbonated with CO2 what helps to preserve the quality of active substances and to improve preservative stability of the beverage, still the consumption of carbonated beverages contributes to upper respiratory ailment.

Until now known stimulating and energizing beverages are chemically preserved and so they can cause problems to people sensitive to preservatives.

### BACKGROUND OF THE INVENTION

The above mentioned disadvantages are eliminated in efficient extent by the beverage according to this invention which is based on the fact that it contains the mixture of guarana extract and tribulus terrestris extract. Their combination is mixed in drinkable liquid, particularly in water. In favourable mixture, the drinkable liquid can contain mineral water or fruit juice.

Guarana is one of the commonly used natural stimulants which support physical activity and high content of natural caffeine. In the past guarana was used in traditional faith healing in jungle of Amazon, nowadays are its overall positive effects known and reliably checked by many experts. Guarana increases the resistance against tiredness and depression. Guarana shows strong anti-allergic effects against E. coli and salmonella (C. A. da Fonseca and editors, Mutation Research 5/94), improves memory (E. B. Espinola, Journal of Ethnopharmacology 2/97). No negative effects of this plant (Paulinia cupana) are known to human organism. The high content of natural caffeine in guarana does not cause any negative effects known from the usage of caffeine in the form of traditional coffee and caffeine beverages. It is because caffeine is fixed to ballast compound and it is absorbed not in stomach as it is with coffee but in intestines likewise green tea. The new solution of energizing beverage according to this invention is the usage of guarana in combination with tribulus terrestris. The extract of the plant tribulus terrestris (Puncture Vine) has a wide range of positive influence on accelerated physical and mental regeneration, on, fat reduction. Tribulus terrestris also helps vasodilatation what helps to lower blood pressure. The combination of the extract of guarana and tribulus terrestris brings to the beverage according to this invention the connection and increase of the effects of individual components and long-lasting effect preservation with no side-effects. This beverage together with new combination of efficient effects gains new positive effects which are long-lasting due to gradual release of efficient components into human organism.

In favourable and vetted configuration the beverage with energizing effects contains 50 to 1500 mg of guarana extract per 1000 ml of the drinkable liquid and 50 to 400 mg of tribulus terrestris extract per 1000 ml of the drinkable liquid. In mentioned combination we gain a beverage which lowers the tendency to atherosclerosis, the sensitivity to weather, it represses the headache of non-rheumatic character, detoxicates blood, lowers temperature, loosens cramps, improves kidney functions, adjusts weight, lightens the mood, improves memory, lowers woman menstrual problems, prevents thrombosis, improves tissue congest, prevents early ageing, normalizes pulse frequency and digesting. The beverage helps to improve urinary problems, increases sexual libido, slowly increases the portion of muscular mass and supports continuous muscle activity.

The drinkable liquid can be water, mineral water or fruit and/or vegetable juice or the combination of the above mentioned liquids.

Used extracts of guarana and tribulus terrestris are gained by maceration of haulm, seeds, perhaps beans of particular plants, favourably so the guarana extract contains 15 to 30% by weight, favourably 22% by weight of natural caffeine and tribulus terrestris extract contains 25 to 60% by weight, favourably 45% by weight of steroid saponins.

Guarana contains high portion of natural caffeine. To increase its effects it can contain additionally, over the extent of guarana content, added caffeine, favourably natural caffeine in amount of 50 to 200 mg per 1000 of drinkable liquid.

To increase preventive and healing effects is the beverage with energizing effects filled by mixture of vitamins from the class C and/or B.

In tested content the beverage may contain per 1000 ml of drinkable liquid 7 to 10 mg, favourably 8.3 mg of thiamine (vitamin B1), 6 to 9 mg, favourably 7.5 mg of pyridoxine (vitamin B6), 3 to 6 μg, favourably 4.5 μg of cyanocobalamin (vitamin B12). Vitamin B1 helps to keep the nervous system and improves mental performance. It is needed for continuous muscle and nervous system activity. Vitamin B6 lowers muscle tension and prevents cramps. Vitamin B12 is co-responsible for proper function of nervous system and plays efficient task in fat, sugar and protein metabolism and erythrocyte creation.

As energy stock in the beverage are used sucrose and glucose and/or fructose. It is favourable if the beverage with energising effects is pasteurised. All the known stimulating and/or energising beverages were saturated by carbohydrate and were not pasteurised. Chemical preservations were used to gain sufficient chemical stability and guarantee. Used preservatives, in combination with no saturation by CO2 allows the beverage according to this invention, to gain pleasant consume characteristics and wide range of usage in mixed beverages. The content of natural CO2 without saturation usually represents the values from 0.0 to 0.7 mg/l.

To improve digestion and to gain stimulating mental effects, the beverage can contain capsaicin. This alkaloid is in its natural form present in chilli.

A three-month clinical research, during which 11 people drank daily the beverage according to this invention, prepared in accordance with the further described example, showed the following: normalization of haemoglobin quantity, LDL cholesterol lowering, slight increase of HDL cholesterol by stable level of VLDL cholesterol. The observed persons drank daily 250 to 500 ml of beverage. The research discovered the stabilisation of blood pressure and body fat decrease, total cholesterol values were lower so they reached the area of physiological range. The tendency to hypertension and values of glycaemia were improved. The observation showed that regular and continuous consumption of the beverage according to this description did not cause any negative effects or complications like diarrhoea, constipation, vomiting, flatulence, heartburn, increased exhaustion, sleeplessness, nervousness, increased irritableness, headache, skin problems.

### EXAMPLE OF INVENTION REALIZATION

Beverage with energizing effects according to this example is made of water solution which contains 150 mg/l guaranin—extract of guarana with 22% by weight content of natural caffeine and 230 mg/l of tribulus terrestris extract with 45% by weight content of steroid saponin. The water solution is sweeten by liquid sweetener based on sucrose (ISOSWEET 250). The content of beverage is enriched by mixture of vitamins from the group B containing: 8.3 mg/l vitamin B1, 7.5 mg/l vitamin B6 and 4.5 μg vitamin B12.

The beverage is enriched by sucrose, fructose, natural aroma, natural colouring and natural caffeine in amount of 160 mg/l.

Such prepared beverage contains zero proteins, zero fat and 108.6 g/l with total energy value of 1870 kJ/l.

### INDUSTRIAL APPLICABILITY

The industrial applicability is obvious. The method of this invention allows industrial production of beverage with energizing effects made of purely natural extracts and without the use of taurine.

1. Beverage with energizing effects, comprising drinkable liquid containing guarana extract and tribulus terrestris extract.

2. Beverage according to claim 1, wherein the drinkable liquid comprises drinkable water and proportions of the guarana extract and the tribulus terrestris extract are 50 to 1500 mg of the guarana extract per 1000 ml of the drinkable water and 50 to 400 mg of the tribulus terrestris extract per 1000 ml of the drinkable water.

3. Beverage according to claim 1, wherein the drinkable liquid comprises mineral water.

4. Beverage according to claim 1, wherein the drinkable liquid comprises a vegetable juice or a fruit juice.

5. Beverage according to claim 1, wherein the guarana extract contains 15 to 30% by weight of natural caffeine.

6. Beverage according to claim 1, wherein the tribulus terrestris extract contains 25% to 60% by weight of steroid saponins.

7. Beverage according to claim 1, further comprising in addition to natural caffeine present in the guarana extract, additional caffeine.

8. Beverage according to claim 1, further comprising a plurality of vitamins selected from the group consisting of B and C vitamins.

9. Beverage according to the claim 8, wherein the beverage contains per 1000 ml of the drinkable liquid, 7 to 10 mg of thiamine, 6 to 9 mg of pyridoxine, and 3 to 6 μg of cyanocobalamin.

10. Beverage according to claim 1, further comprising at least one of sucrose, glucose or fructose.

11. Beverage according to claim 1, wherein the beverage is pasteurized.

12. Beverage according to claim 1, further comprising carbohydrate in a proportion up to 7 mg/l of the beverage.

13. Beverage according to claim 1, further comprising capsaicin.

14. Beverage according to claim 5, wherein the guarana extract contains 22% by weight of natural caffeine.

15. Beverage according to claim 6, wherein the tribulus terrestris extract contains 45% by weight of steroid saponins.

16. Beverage according to claim 7, wherein the added caffeine is natural caffeine in a proportion of 50 to 200 mg per 1000 ml of the drinkable liquid.

17. Beverage according to claim 9, wherein the beverage contains per 1000 ml of the drinkable liquid, 8.3 mg of thiamine, 7.5 mg of pyroxidine and 4.5 μg of cyanocobalamin.
